(19) United States
(12) Patent Application Publication
(10) Pub. No.: US 2015/0160484 A1
(43) Pub. Date: Jun. 11, 2015

(54) LIQUID CRYSTAL DISPLAY AND METHOD FOR MANUFACTURING THE SAME

(71) Applicant: SHENZHEN CHINA STAR OPTOELECTRONICS CO., LTD., Shenzhen, Guangdong (CN)

(72) Inventor: Ming Liu, Shenzhen (CN)

(21) Appl. No.: 14/127,490

(22) PCT Filed: Dec. 6, 2013
(86) PCT No.: PCT/CN2013/088789

§ 371 Date: Dec. 19, 2013

(51) Int. Cl. G02F 1/1339

(52) U.S. Cl. CPC G02F 1/1339

(57) ABSTRACT

The present disclosure provides a liquid crystal panel and a method for manufacturing the liquid crystal panel. By forming the edge structure between the display area and the sealant, the liquid crystal layer on the display area can be separated from the sealant by the edge structure to effectively avoid direct contact between the liquid crystal and the sealant. In addition, since the liquid crystal layer and the sealant are coated on the same substrate, the occurrence possibility of defect is effectively reduced, the product quality is improved, and the production cost is reduced.

### BACKGROUND

1. Technical Field

The present disclosure relates to technologies of liquid crystal displays, and more particularly, to a liquid crystal display and a method for manufacturing the liquid crystal display.

2. Description of Related Art

Displays become indispensable in people's daily life. Types of the displays include CRT (Cathode Ray Tube), LED (Light Emitting Diode), TFT-LCD (Thin Film Transistor-Liquid Crystal Display), PDP (Plasma Display Panel), etc. At present, most of the displays in the market are TFT-LCD displays.

A TFT-LCD display mainly includes two glass substrates. One of the substrates forms a circuit matrix by an Array process and the other one of the substrates forms a red, green, and blue color film by a CF (Color Filter) process. Liquid crystal is dropped onto the two substrates by a Cell process. After a sealant is coated on the two substrates, the two substrates are bonded together and thereafter become a product such as a TFT-LCD television or a display by a module process.

In the Cell process, liquid crystal is ejected into a space between the Array substrate and the CF substrate. The Array substrate and the CF substrate are bonded together without air in the space defined between the Array substrate and the CF substrate to ensure a normal display function of the liquid crystal panel. Therefore, the sealant is required to be coated on the Array substrate or the CF substrate to seal the space defined between the Array substrate and the CF substrate. In order to provide a normal display function, the property of the liquid crystal cannot be changed, thus, a reaction between the sealant and the liquid crystal should be avoided in the process of coating the sealant on the Array substrate or the CF substrate.

At present, the reaction between the liquid crystal and the sealant can be avoided by a method as follows: coating the liquid crystal and the sealant on the two substrates respectively and then bonding the two substrates together to prevent the liquid crystal from contacting the sealant directly. After that, the sealant is cured by a heat curing method and/ or a light curing method (the cured sealant does not react with the liquid crystal). This method ensures that there is no gap between the Array substrate and the CF substrate and effectively avoids the reaction between the liquid crystal and the sealant.

Although the above method in which the liquid crystal and the sealant are coated on the two substrates effectively prevents the liquid crystal from contacting the sealant directly, the difficulty of bonding the two substrates is increased and the accuracy of bonding the two substrates is also influenced. Moreover, since the operation relates to two substrates, the occurrence possibility of defect is increased. In addition, two production lines (one of the production lines corresponds to the Array substrate and the other one of the production lines corresponds to the CF substrate) are required, which increases the cost of the equipment and increases the difficulty and inconstancy of the production process.

### SUMMARY

The main object of the present disclosure is to provide a liquid crystal panel and a method for manufacturing the liquid crystal panel, for effectively avoiding direct contact between the liquid crystal and the sealant. In addition, coating the liquid crystal layer and the sealant on the same substrate reduces the occurrence possibility of defect, improves the product quality, and reduces the production cost.

The liquid crystal panel provided in the present disclosure includes:

a first substrate and a second substrate arranged in a position opposite to the first substrate, the first substrate and the second substrate respectively having a display area and a non-display area surrounding the display area;

a liquid crystal layer formed between the two display areas of the first substrate and the second substrate;

a sealant for bonding the first substrate and the second substrate, the sealant being arranged between the two non-display areas of the first substrate and the second substrate and surrounding the display area; and

an edge structure configured on the first substrate, the edge structure surrounding the display area and being located between the display area and the sealant.

Preferably, a thickness of the edge structure is greater than or equal to that of the liquid crystal layer, and is less than that of the sealant.

Preferably, the thickness of the edge structure is B and a range of B is: 3.0 um≦B≦4.5 um.

Preferably, the first substrate is a TFT substrate or a CF substrate.

The method for manufacturing a liquid crystal panel provided in the present disclosure, including:

providing a first substrate having a display area and a non-display area and configuring an edge structure surrounding the display area on the non-display of the first substrate;

forming a liquid crystal layer on the display area of the first substrate and arranging a sealant surrounding the edge structure on the non-display area of the first substrate; and

providing a second substrate, facing the second substrate towards the sealant and the edge structure and pressing the second substrate on top of the first substrate, curing the sealant to bond the first substrate and the second substrate.

Preferably, a thickness of the edge structure is greater than or equal to that of the liquid crystal layer, and is less than that of the sealant.

Preferably, the thickness of the edge structure is B and a range of B is: 3.0 um≦B≦4.5 um.

Preferably, the first substrate is a TFT substrate or a CF substrate.

Another method for manufacturing a liquid crystal panel provided in the present disclosure, including:

providing a first substrate having a display area, a non-display area, and an edge structure which is arranged on the non-display and surrounds the display area;

forming a liquid crystal layer on the display area of the first substrate and forming a sealant surrounding the edge structure on the non-display area of the first substrate; and

providing a second substrate, facing the second substrate towards the sealant and the edge structure and pressing the second substrate on top of the first substrate, curing the sealant to bond the first substrate and the second substrate.

Preferably, a thickness of the edge structure is greater than or equal to that of the liquid crystal layer, and is less than that of the sealant.

Preferably, the thickness of the edge structure is B and a range of B is: 3.0 um≦B≦4.5 um.

Preferably, the first substrate is a TFT substrate or a CF substrate.

By configuring the edge structure between the display area and the sealant, the liquid crystal layer is separated from the sealant by the edge structure to effectively avoid direct contact between the liquid crystal and the sealant. In addition, coating the liquid crystal layer and the sealant on the same substrate reduces the occurrence possibility of defect, improves the product quality, and reduces the production cost.

### DESCRIPTION OF THE DRAWINGS

Many aspects of the embodiments can be better understood with reference to the following drawings. The components in the drawings are not necessarily dawns to scale, the emphasis instead being placed upon clearly illustrating the principles of the embodiments. Moreover, in the drawings, like reference numerals designate corresponding parts throughout the several views.

FIG. 1 is a schematic view of a partially schematic view of a liquid crystal panel in accordance with an embodiment of the present disclosure;

FIG. 2 is a cross-sectional view of the liquid crystal panel of FIG. 1;

FIG. 3 is a flow chart of a method for manufacturing a liquid crystal panel in accordance with a first embodiment of the present disclosure; and

FIG. 4 is a flow chart of a method for manufacturing a liquid crystal panel in accordance with a second embodiment of the present disclosure.

### DETAILED DESCRIPTION

The disclosure is illustrated by way of example and not by way of limitation in the figures of the accompanying drawings in which like references indicate similar elements. It should be noted that references to “an” or “one” embodiment is this disclosure are not necessarily to the same embodiment, and such references mean at least one.

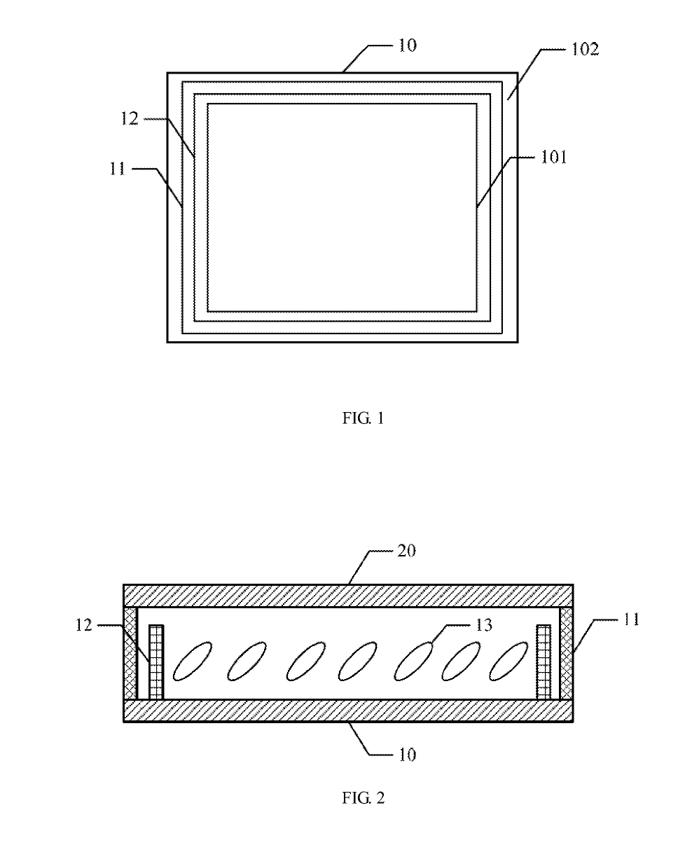

Referring to FIGS. 1 and 2, the liquid crystal panel provided in the present disclosure includes a first substrate 10, a second substrate 20 arranged in a position opposite to the first substrate 10, a liquid crystal layer 13, and a sealant 11 for bonding the first substrate 10 and the second substrate 20. The first substrate 10 and the second substrate 20 respectively define a display area 101 and a non-display area 102 surrounding the display area 101. The liquid crystal layer 13 is formed between the two display areas 101 of the first substrate 10 and the second substrate. The sealant 11 is arranged between the two non-display areas 102 and surrounds the two display areas 101. The liquid crystal panel further includes an edge structure 12 configured on the first substrate 10. The edge structure 12 surrounds the display area 101 and is located between the display area 101 and the sealant 11. The edge structure 12 surrounds the display area 101 and is a closed structure.

In the embodiment, after the edge structure 12 surrounding the display area 101 is configured on the substrate 10, the liquid crystal layer 13 is formed on the display area of the first substrate 10. After the liquid crystal layer 13 is formed on the display area 101 of the substrate 10, the sealant 11 surrounding the edge structure is arranged on the first substrate 10. The second substrate 20 faces the sealant 11 and the edge structure 12 and is thereafter pressed on top of the first substrate 1 to bond the first substrate 10 and the second substrate 20 together. With the edge structure 12 configured between the display area 101 and the sealant 11, the liquid crystal layer 13 formed on the display area 101 is separated from the sealant 11 to avoid direct contact between the liquid crystal layer 13 and the sealant 11. In the embodiment, the first substrate 10 is a TFT substrate. In other embodiments, the first substrate 10 is a CF substrate.

By configuring the edge structure 12 between the display area 101 and the sealant 11, the edge structure 12 separates the liquid crystal layer 13 arranged on the display area 101 from the sealant 11 to effectively avoid direct contact between the liquid crystal layer and the sealant 11. In addition, coating the liquid crystal layer and the sealant 11 on the same substrate effectively reduces the occurrence possibility of defect, improves the product quality, and reduces the production cost.

Furthermore, in order to ensure a better realization of coating the liquid crystal layer 13 on the display area 101 of the first substrate 10, the edge structure is coated along an outer side of the edge of the display area 101 of the first substrate 10 and thus there is no gap between the edge structure 12 and the display area 101. That is, the area on which the liquid crystal layer 13 is coated is restricted by the edge structure 12, which prevents the liquid crystal layer 13 from being coated on the non-display area 102 and more accurately restricts the liquid crystal layer 13 on the display area 101 of the substrate 10. In this way, the liquid crystal panel has a better display effect. In other embodiments of the present disclosure, a gap can be defined between the edge structure 12 and the display area 101.

Furthermore, in order to better separate the liquid crystal layer 13 from the sealant 11 and prevent the liquid crystal from flowing across the edge structure to contact the sealant 11, a thickness of the edge structure 12 is greater than or equal to that of the liquid crystal layer 13. That is, a distance between a top surface of the edge structure 12 and the second substrate 20 is less than or equal to the distance between a top surface of the liquid crystal layer 13 and the second substrate 20.

Furthermore, in order to better save the production cost, the thickness of the edge structure 12 is less than that of the sealant 11. In other embodiments, the thickness of the edge structure 12 can be equal to that of the sealant 11.

Furthermore, on the basis of saving the production cost, in order to better separate the liquid crystal layer 13 from the sealant 11, the thickness of the edge structure is B and the range of B is as follows: 3.0 um≦B≦4.5 um.

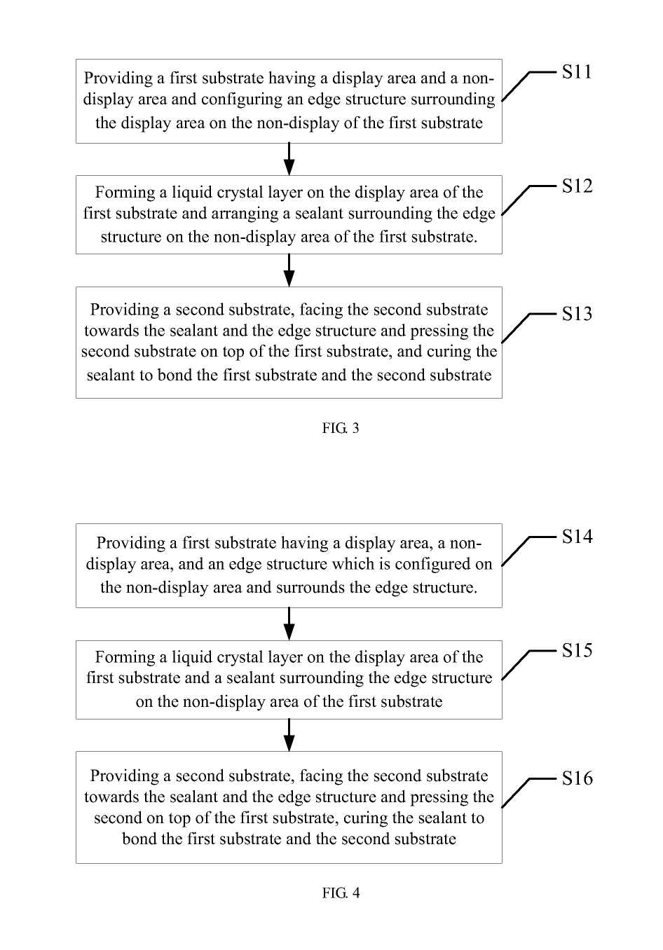

As shown in FIG. 3, the present disclosure further provides a method for manufacturing a liquid crystal panel, which is given in detail as follows.

Step S11, providing a first substrate having a display area and a non-display area and configuring an edge structure surrounding the display area on the non-display of the first substrate.

Step S12, forming a liquid crystal layer on the display area of the first substrate and arranging a sealant surrounding the edge structure on the non-display area of the first substrate.

Step S13, providing a second substrate, facing the second substrate towards the sealant and the edge structure and pressing the second substrate on top of the first substrate, and curing the sealant to bond the first substrate and the second substrate.

In detail, after the first substrate having the display area and the non-display area is provided, the edge structure surrounding the display area is configured on the non-display area of the first substrate and liquid crystal is dropped onto the display area of the first substrate via a liquid crystal dropper to form the liquid crystal layer on the display area of the first substrate. After the liquid crystal layer is formed on the display area of the first substrate, material for making the sealant is dropped around the edge structure via a dropper, thereby forming the sealant on the non-display area. The sealant surrounds the display area and is a closed structure. Similarly, the edge structure surrounds the display area and is also a closed structure. The edge structure and the sealant can be made of the same material. After being dropped onto the non-display area, the material for making the sealant is cured to form the edge structure which does not react with the liquid crystal layer on the non-display area. The material for making the edge structure can be any suitable material which does not react with the liquid crystal layer. With the edge structure formed between the display area and the sealant, the liquid crystal layer formed on the display area is separated from the sealant to avoid direct contact between the liquid crystal layer and the sealant.

By configuring the edge structure between the display area and the sealant, the liquid crystal layer is separated from the sealant by the edge structure, thus, direct contact between the liquid crystal and the sealant can be avoided. In addition, since the liquid crystal layer and the sealant are coated on the same substrate, the occurrence possibility of defect is effectively reduced, the product quality is improved, and the production cost is correspondingly reduced.

Furthermore, in order to ensure a better realization of coating the liquid crystal layer 13 on the display area 101 of the first substrate 10, the edge structure is coated along an outer side of the edge of the display area 101 of the first substrate 10 and thus there is no gap between the edge structure 12 and the display area 101. That is, the area on which the liquid crystal layer 13 is coated is restricted by the edge structure 12, which prevents the liquid crystal layer 13 from being coated on the non-display area 102 and more accurately restricts the liquid crystal layer 13 on the display area 102 of the substrate 10. In this way, the liquid crystal panel has a better display effect. In other embodiments of the present disclosure, a gap can be defined between the edge structure 12 and the display area 101.

Furthermore, in order to better separate the liquid crystal layer from the sealant and prevent the liquid crystal from flowing across the edge structure to contact the sealant, a thickness of the edge structure is greater than or equal to that of the liquid crystal layer. That is, a distance between a top surface of the edge structure and the second substrate is less than or equal to the distance between a top surface of the liquid crystal layer and second substrate.

Furthermore, in order to better save the production cost, the thickness of the edge structure is less than that of the sealant. In other embodiments, the thickness of the edge structure can be equal to that of the sealant.

Furthermore, on the basis of saving the production cost, in order to better separate the liquid crystal layer from the sealant, the thickness of the edge structure is B and the range of B is as follows: 3.0 um≦B≦4.5 um.

Referring to FIG. 4, the present disclosure further provides another method for manufacturing a liquid crystal panel, which is given in detail as follows.

Step S14, providing a first substrate having a display area, a non-display area, and an edge structure which is configured on the non-display area and surrounds the edge structure.

Step S15, forming a liquid crystal layer on the display area of the first substrate and a sealant surrounding the edge structure on the non-display area of the first substrate.

Step S16, providing a second substrate, facing the second substrate towards the sealant and the edge structure and pressing the second on top of the first substrate, curing the sealant to bond the first substrate and the second substrate.

In detail, in the step of providing the first substrate having the display area, the non-display area and the edge structure which is configured on the non-display area and surrounds the display area, if the first substrate is a TFT substrate, the edge structure can be simultaneously formed with any structure of the TFT substrate to save the manufacturing process and improve the productivity; if the first substrate is a CF substrate, the edge structure can be simultaneously formed with any structure of the CF substrate. In other embodiments of the present disclosure, the edge structure can be independently formed.

Liquid crystal is dropped onto the display area of the first substrate via a liquid crystal dropper to form the liquid crystal layer on the display area of the first substrate. After the liquid crystal layer is formed on the display area of the first substrate, material for making the sealant is dropped around the edge structure via a dropper, thereby forming the sealant on the non-display area. The sealant surrounds the display area and is a closed structure. Similarly, the edge structure surrounds the display area and is also a closed structure. The edge structure and the sealant can be made of the same material. After being dropped onto the non-display area, the material for making the sealant is cured to form the edge structure which does not react with the liquid crystal layer on the non-display area. The material for making the edge structure can be any suitable material which does not react with the liquid crystal layer. With the edge structure formed between the display area and the sealant, the liquid crystal layer formed on the display area is separated from the sealant to avoid direct contact between the liquid crystal layer and the sealant.

By configuring the edge structure between the display area and the sealant, the liquid crystal layer is separated from the sealant by the edge structure, thus, direct contact between the liquid crystal and the sealant can be avoided. In addition, since the liquid crystal layer and the sealant are coated on the same substrate, the occurrence possibility of defect is effectively reduced, the product quality is improved, and the production cost is correspondingly reduced.

Furthermore, in order to ensure a better realization of coating the liquid crystal layer on the display area of the first substrate, the edge structure is coated along an outer side of the edge of the display area of the first substrate and thus there is no gap between the edge structure and the display area. That is, the area on which the liquid crystal layer is coated is restricted by the edge structure, which prevents the liquid crystal layer from being coated on the non-display area and more accurately restricts the liquid crystal layer on the display area of the substrate. In this way, the liquid crystal panel has a better display effect. In other embodiments of the present disclosure, a gap can be defined between the edge structure and the display area.

Furthermore, in order to better separate the liquid crystal layer from the sealant and prevent the liquid crystal from flowing across the edge structure to contact the sealant, a thickness of the edge structure is greater than or equal to that of the liquid crystal layer. That is, a distance between a top surface of the edge structure and the second substrate is less than or equal to the distance between the top surface of the liquid crystal layer and second substrate.

Furthermore, in order to better save the production cost, the thickness of the edge structure is less than that of the sealant. In other embodiments, the thickness of the edge structure can be equal to that of the sealant.

Furthermore, on the basis of saving the production cost, in order to better separate the liquid crystal layer from the sealant, the thickness of the edge structure is B and the range of B is as follows: 3.0 um≦B≦4.5 um.

Even though information and the advantages of the present embodiments have been set forth in the foregoing description, together with details of the mechanisms and functions of the present embodiments, the disclosure is illustrative only; and that changes may be made in detail, especially in matters of shape, size, and arrangement of parts within the principles of the present embodiments to the full extend indicated by the broad general meaning of the terms in which the appended claims are expressed.

What is claimed is:

1. A liquid crystal panel, comprising:
a first substrate and a second substrate arranged in a position opposite to the first substrate, the first substrate and the second substrate respectively having a display area and a non-display area surrounding the display area;
a liquid crystal layer formed between the two display areas of the first substrate and the second substrate;
a sealant for bonding the first substrate and the second substrate, the sealant being arranged between the two non-display areas of the first substrate and the second substrate and surrounding the display area; and
an edge structure configured on the first substrate, the edge structure surrounding the display area and being located between the display area and the sealant.

2. The liquid crystal panel of claim 1, wherein a thickness of the edge structure is greater than or equal to that of the liquid crystal layer, and is less than that of the sealant.

3. The liquid crystal panel of claim 2, wherein the thickness of the edge structure is B and a range of B is: 3.0 um≦B≦4.5 um.

4. The liquid crystal panel of claim 2, wherein the first substrate is a TFT substrate or a CF substrate.

5. The liquid crystal panel of claim 1, wherein the thickness of the edge structure is B and a range of B is: 3.0 um≦B≦4.5 um.

6. The liquid crystal panel of claim 1, wherein the first substrate is a TFT substrate or a CF substrate.

7. A method for manufacturing a liquid crystal panel, comprising:
providing a first substrate having a display area and a non-display area and configuring an edge structure surrounding the display area on the non-display of the first substrate;
forming a liquid crystal layer on the display area of the first substrate and arranging a sealant surrounding the edge structure on the non-display area of the first substrate; and
providing a second substrate, facing the second substrate towards the sealant and the edge structure and pressing the second substrate on top of the first substrate, curing the sealant to bond the first substrate and the second substrate.

8. The method of claim 7, wherein a thickness of the edge structure is greater than or equal to that of the liquid crystal layer, and is less than that of the sealant.

9. The method of claim 8, wherein the thickness of the edge structure is B and a range of B is: 3.0 um≦B≦4.5 um.

10. The method of claim 8, wherein the first substrate is a TFT substrate or a CF substrate.

11. The method of claim 7, wherein the thickness of the edge structure is B and a range of B is: 3.0 um≦B≦4.5 um.

12. The method of claim 7, wherein the first substrate is a TFT substrate or a CF substrate.

13. A method for manufacturing a liquid crystal panel, comprising:
providing a first substrate having a display area, a non-display area, and an edge structure which is arranged on the non-display and surrounds the display area;
forming a liquid crystal layer on the display area of the first substrate and forming a sealant surrounding the edge structure on the non-display area of the first substrate; and
providing a second substrate, facing the second substrate towards the sealant and the edge structure and pressing the second substrate on top of the first substrate, curing the sealant to bond the first substrate and the second substrate.

14. The method of claim 13, wherein a thickness of the edge structure is greater than or equal to that of the liquid crystal layer, and is less than that of the sealant.

15. The method of claim 14, wherein the thickness of the edge structure is B and a range of B is: 3.0 um≦B≦4.5 um.

16. The method of claim 14, wherein the first substrate is a TFT substrate or a CF substrate.

17. The method of claim 13, the thickness of the edge structure is B and a range of B is: 3.0 um≦B≦4.5 um.

18. The method of claim 13, wherein the first substrate is a TFT substrate or a CF substrate.
